(19) United States
(12) Patent Application Publication
(10) Pub. No.: US 2025/0317813 A1
(43) Pub. Date: Oct. 9, 2025

(54) DUAL BLUETOOTH TRANSCEIVER COMMUNICATIONS

(71) Applicant: Hewlett-Packard Development Company, L.P., Spring, TX (US)

(72) Inventors: Wei-Ming Lo, Taipei City (TW); Chung-Chun Chen, Taipei City (TW); Hsiao-Ling Hsieh, Taipei City (TW); Chih-Ming Huang, Taipei City (TW); Cheng-Wei Chiu, Taipei City (TW)

(73) Assignee: Hewlett-Packard Development Company, L.P., Spring, TX (US)

(21) Appl. No.: 18/629,569

(22) Filed: Apr. 8, 2024

(51) Int. Cl. H04W 36/00; H04W 72/542; H04W 76/15

(52) U.S. Cl. CPC H04W 36/00692; H04W 72/542; H04W 76/15

(57) ABSTRACT

An example electronic device with several wireless communication modules for increase in connectivity quality and throughput of data transmission to receiving devices. The electronic device establishes a first connection with a receiving device utilizing a first wireless communication module and determines to establish a second connection with the receiving device, in parallel with the first wireless communication module, utilizing a second wireless communication module based on determined packet losses. The electronic device may further alternate packet transmission from the first wireless communication module to the second wireless communication module bases on a determination that the first wireless communication module signal quality is below a predefined threshold. The electronic device may further establish a connection with the receiving device utilizing the first wireless communication module or second wireless communication module as a standby connection.

### BACKGROUND

Electronic devices with wireless communication capabilities have significantly increased and altered with emerging technologies along with wireless communication capabilities. In some examples, electronic devices can utilize radio frequency-based communications and protocols to provide network communications. In some examples, electronic devices can utilize different configurations of wireless communication networks, such as wireless network configurations associated with short-range and long-range communications. One example of a short-range wireless communication configuration corresponds to various implementations of short-range wireless standards promulgated by the Bluetooth Special Interest Group, generally referred to as “Bluetooth.”

The utilization of Bluetooth enabled communication components within transmitting and receiving electronic devices facilitates data transferring and wireless communication and the building of personal area networks (PANs). More specifically, in some examples, electronic computing devices may be configured with a Bluetooth enabled communication component to facilitate data transmission with receiving devices, such as peripheral devices, without the requirement of a physical connection to the electronic computing device.

### BRIEF DESCRIPTION OF THE DRAWINGS

Various features will now be described with reference to the following drawings. Throughout the drawings, reference numbers may be re-used to indicate correspondence between referenced elements. The drawings are provided to illustrate examples described herein and are not intended to limit the scope of the disclosure.

FIG. 1A is an example diagram of a system including an mobile electronic device for data transmission to a recipient device via wireless communication methods.

FIG. 1B is an example diagram of a system including congestion device(s) and an mobile electronic device for data transmission to a recipient device via wireless communication methods.

FIG. 2 depicts a block diagram of an example architecture of an electronic device including wireless communication in accordance with illustrative examples.

FIG. 3 is a flow diagram of a routine implemented by an mobile electronic device communicating with a recipient device in accordance with illustrative examples.

FIG. 4 is a flow diagram of a routine implemented by an mobile electronic device communicating with a recipient device in accordance with illustrative examples.

FIG. 5 is another flow diagram of a routine implemented by an mobile electronic device communicating with a recipient device in accordance with illustrative examples.

FIG. 6A-6C are examples of filter profiles for a wireless component in accordance with illustrative examples.

### DETAILED DESCRIPTION

Certain examples described herein provide electronic devices, apparatus, and computer-readable media for dual wireless transceiver communications with recipient devices. In some examples, the wireless transmissions correspond to short-range wireless transmission protocols defined in the short-range wireless technology standard promulgated by the Bluetooth SIG. Such short-range wireless transmission protocols can be characterized, illustratively, by transmission power below 2.5 milliwatts and employing ultra-high frequency (UHF) radio waves with wavelengths of 2.402 GHz to 2.48 GHz. General reference to the term “Bluetooth” can encompass various versions of the wireless transmission protocol, and include various configurations or implementations of specific versions thereof. Accordingly, reference to Bluetooth and Bluetooth-enabled devices/components should not be limited any particular version of the wireless transmission protocol including future versions not currently adopted and not departing from the spirit and scope of the standards promulgated by the Bluetooth SIG (or its successors or competitors).

Illustratively, an electronic device may be configured with two Bluetooth wireless transceiver components (at least two Bluetooth wireless transceiver components). Each wireless transceiver component is functionally operable to independently transmit short range wireless transmissions with recipient device(s). More specifically, an electronic device can include a controller, or sets of controllers, for independently configuring a first and a second Bluetooth communication component to establish communications. In some examples, the first and second Bluetooth communication components will establish separate communication channels with an identified recipient device. According to various examples, the configuration of the communication channels can include handover events in which either the first or second Bluetooth transceiver component is considered a primary transceiver component or in an active state and the other transceiver component is considered as a backup transceiver component or in a standby state. According to other examples, the configuration of the communication channels can include events in which either both the first and the second Bluetooth transceiver component are considered a primary transceiver component and in an active state. Still further, in accordance with various examples described herein, the electronic device controller can implement various methodologies for allocating data packet transmissions between the first and the second Bluetooth wireless transceiver components.

Illustratively, an example of the electronic device may be a personal electronic device (e.g., personal computers, laptops, mobile phones, tablets, etc.,) where the electronic device may communicate to a recipient device using a first Bluetooth wireless transceiver component and a second Bluetooth wireless transceiver component.

An example of the recipient device may be a second personal electronic device (e.g., personal computers, laptops, mobile phones, tablets, etc.,) where the electronic device may transmit data packets utilizing the first and second Bluetooth wireless transceiver components for file transferring and/or audio transmission. Another example of the recipient device may be an audio device with wireless communication capabilities, wherein the electronic device transmits audio data in real-time.

Certain examples described herein provide a computing system with several wireless communication modules where at least two of the wireless communications modules are Bluetooth wireless transceiver components and may operate on the same frequency channel or different frequency channels. The computing system may establish a connection with the recipient device using the first Bluetooth wireless transceiver component and the second Bluetooth wireless transceiver component using a first and second frequency channel.

Implementation of the example of the electronic device enables an increase of connection stability, range of connection between the electronic device and the recipient device, and throughput of transmitted data packets between the electronic device and recipient devices that are connected to the electronic device. The electronic device may further configure a first or second wireless transmit data packets (through the first and second Bluetooth wireless transceiver components) to the recipient device using a configurable sequence of data transmission using the first wireless communication module and second wireless communication module individually or in combination with.

The system as described includes an electronic device that may include several wireless communication modules. Illustratively, the wireless communication modules may be Bluetooth wireless transceiver components operating on the same or different frequency channels. A user operating the electronic device may instruct the electronic device to establish a first connection with a first electronic device, which may be mobile, using the first wireless communication module and establish a second connection with recipient device using the second wireless communication module. The first connection may be an active connection wherein the electronic device is actively transmitting data packets to an electronic device. The second connection may be an inactive connection (or an inactive state) such that the electronic device establishes and retains the second connection with the recipient device as a standby connection.

Illustratively, an example of establishing the second connection with the recipient device via the electronic device using the first connection with the electronic device. The electronic device obtains identification information (e.g., media access control (MAC) address) from the first connection and communicates the identification information to the second wireless communication module to establish the second connection.

In some examples, the recipient device may be actively receiving data packets from the electronic device via the first connection and experience packet loss during the data transmission, the recipient device may detect the packet losses and inform the electronic device as part of a header information defined in the wireless transmission protocol. Packet loss information may be reported continuously or periodically by the recipient device. The electronic device, based on receiving the packet loss detection, enables the second connection with the recipient device to actively transmit data packets to the recipient device in parallel with the first connection. In this example, both the first and second wireless communication modules can be considered to be in an active (or primary) state.

In some examples, data transmission utilizing the first connection and second connection may be executed using by the electronic device using a configurable transmission sequence and further configured to transmit the data packets as duplicates. The sequence may be enabled using a wireless transmission filter wherein the filter may apply the configured sequence to the data transmission. The data packets may be transmitted in a sequence of subdivided equal sized blocks that are numbered sequentially. The recipient device may receive data packets in any particular order and reconstruct the received data packets based on the sequential order. The sequential numbering of each packet allows the recipient device to identify missing data packets that were not received or otherwise corrupted. Additionally, the sequential number allows for identification of duplicative data packets, one of which can be discarded. Such examples may be beneficial in applications characterized as real-time or substantially real time in nature.

In other examples, the recipient device may be actively receiving data packets from the electronic device via the first connection. At some time, the recipient device may detect the packet losses (as described above). The recipient device can then transmit information to the electronic device including transmission metric information indicative of packet loss according to transmission utilizing the first connection. The electronic device, receives the transmission metric information and can determine that packet loss has occurred (or a sufficient amount of packet loss has occurred) to enable the second connection with the recipient device. In this regard, the second wireless communication module can enter into an active state (or primary state) to actively transmit data packets to the recipient device in parallel with the first connection with a configured transmission sequence. The wireless transmission filter may further include an interleaver to re-organize data packets for transmission, advantageously avoiding burst error via the first connection and second connection. The interleaver may organize the data packets in a manner that randomizes errors that the recipient device may not detect. Such examples may be beneficial in application characterized as non-real time in nature.

In accordance with further examples, the electronic device may connect with the recipient device via a first connection utilizing a first wireless communication module configured a first operating frequency and a second connection utilizing a second wireless communication module configured at a second operating frequency. The first and second operating frequencies are different (e.g., non-overlapping frequency bandwidths). The first wireless communication module may be configured for implementing adaptive frequency hopping (AFH) for data transmission of data packets on a frequency channel with less channel congestion. Illustratively, in accordance with AFH, the frequency of a communication channel can be periodically changed to one of a defined set of channels of fixed bandwidth (e.g., 79 channels each of 1 MHz bandwidth). The first wireless communication module may actively utilize AFH to determine, based on transmission metric information, the least congested frequency channel avoiding transmission errors and packet loss. Illustratively, the transmission metric information can include Received Signal Strength (RSSI), Packet or Bit Error Rate (PER/BER), and Signal to Noise Ratio (SNR). Furthermore, the electronic device also configures a second wireless communication module implementing and actively utilize AFH to determine the least congested frequency channel with respect to the frequency channels the second wireless communication module may operate on.

The electronic device receives from the first wireless communication module and second wireless communication module information regarding AFH results, e.g., the transmission metric information for each respective communication channel. Based on the results, the electronic device may determine to configure the first wireless communication module or second wireless communication module to actively transmit data packets to the electronic device. In some examples, the electronic device may determine to AFH results of the first wireless communication module are preferrable for data transmission and may configure to establish a connection with the recipient device via the first wireless communication module. The electronic device may receive an identification information of the second wireless communication module and communicate the identification information to the recipient device to establish the second connection with the recipient device as a standby connection.

In some examples, the electronic device utilized a third wireless communication module (e.g., Wi-Fi module) to identify if the recipient device is actively moving in a local area, determining motion information. The mobility of the recipient device may cause the recipient device to enter a zone with a higher number of congesting devices. Examples of congesting devices may be other electronic devices operating on identical frequency channels in a local area. The third wireless communication module may inform the electronic device of the active mobility of the recipient device wherein the electronic device requests the first wireless communication module and second wireless communication perform an AFH scan to determine a frequency channel with the least amount of congestion. Based on the AFH scan results the electronic device may continue to transmit data packets to the recipient device utilizing the first wireless communication module.

In another example the electronic device may determine, based on the AFH scan results the first wireless communication module is operating in a high congestion area, the electronic device may request the first wireless communication module to perform a signal quality analysis (e.g., signal-to-noise ratio (SNR), packet error rate (PER), bit error rate (BER)) of the first connection to determine signal quality information associated with the first wireless connection, and report the results to the electronic device. The electronic device in the first example, may determine the signal quality analysis is less than a threshold where the signal quality is adequate for continued use. In another example, the electronic device may determine the signal quality analysis is greater than a threshold where the signal quality is inadequate for data transmission, the electronic device may request the second wireless communication module to transmit data packets actively to the recipient device and request the first wireless communication module as a standby connection.

The illustrative examples as described above are mere example of an embodiment of the system and not limiting the system as described above based on the examples provided. Furthermore, the examples as presented with respect to the signal analysis are non-limiting examples of determining a quality of a signal, the quality of a signal transmission may be further determined by signal quality metrics of the like.

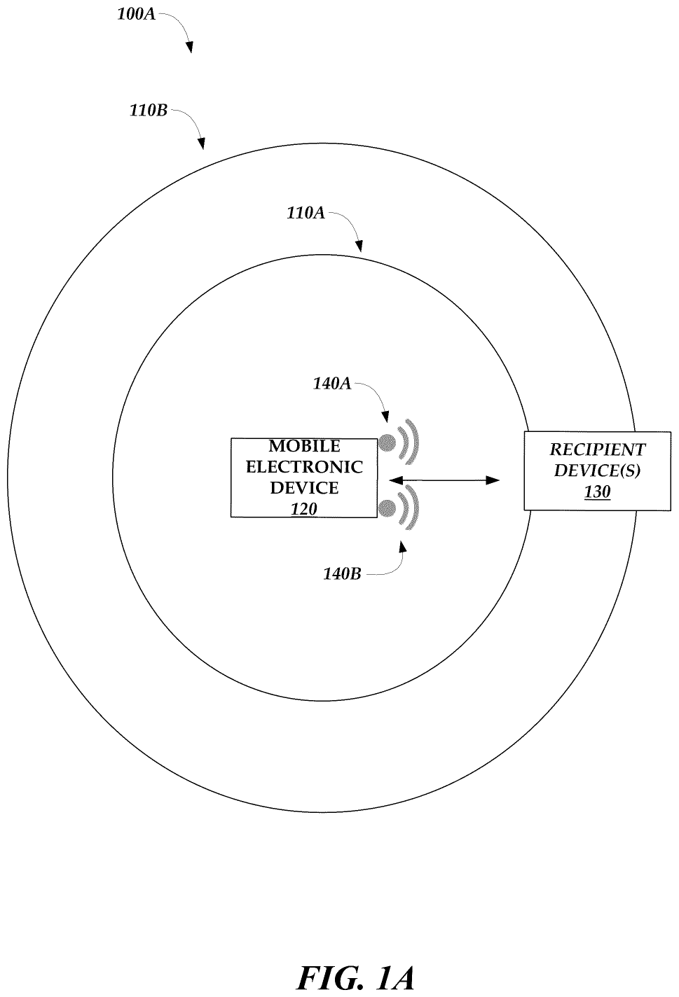

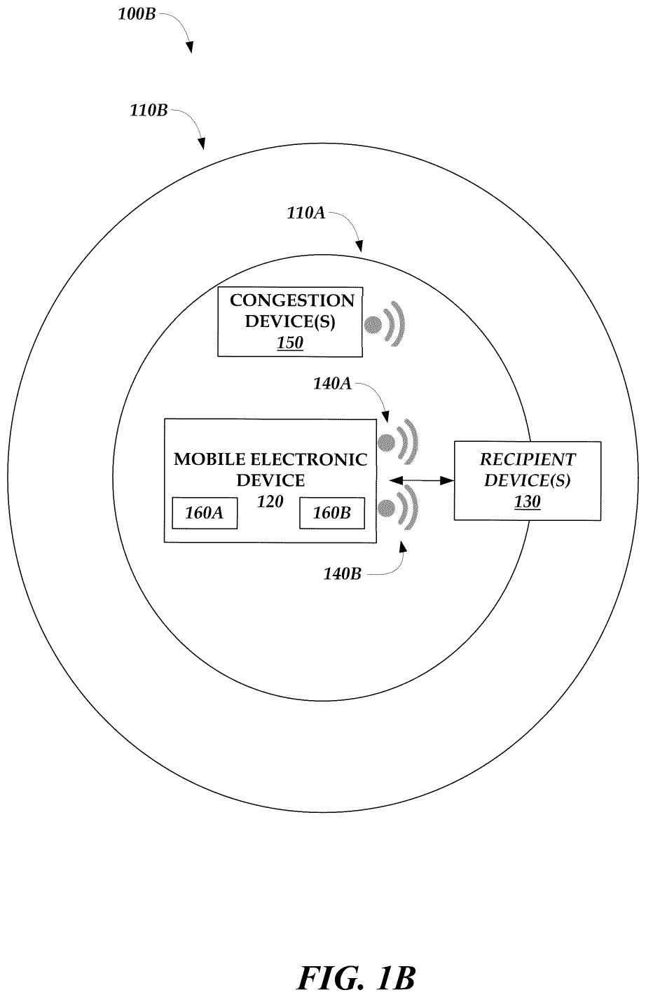

FIG. 1A is a system diagram of an example embodiment of system 100A for implementing a dual Bluetooth transceiver communication system in accordance with various aspects of the present application. System 100A includes an mobile electronic device 120 that is comprised of a first wireless communication module 140A and a second wireless communication module 140B that enable wireless communication (e.g., file transfer, data streaming) with a recipient device(s) 130. Illustratively, the first wireless communication module 140A and the second wireless communication module 140B are independently configurable and independently operable for use the mobile electronic device 120.

Illustratively, mobile electronic device 120 and the recipient device(s) 130 may be mobile such that a distance between the two devices is dynamic. Additionally, the first wireless communication module 140A may have a maximum range of communication, also known as a first maximum range 110A. Generally described, when the recipient device(s) 130 when within the first maximum range 110A may communicate with the mobile electronic device 120 such that packet loss or signal quality due to distance of the transmission is above a threshold. The first maximum range 110A may be determined by factors such as the frequency the first wireless communication module 140A is configured to operate, transmission power configured for at ideal operating range of the first wireless communication module 140A, the physical layer (PHY) configuration of the first wireless communication module 140A, gain of the signal transmission from the first wireless communication module 140A, and examples of the like.

The second wireless communication module may have a maximum range of communication, also known as a second maximum range 110B, wherein the recipient device(s) 130 when within the second maximum range 110B may communicate with the mobile electronic device 120 such that packet loss or signal quality due to distance of the transmission is above a threshold. The second maximum range 110B may be determined by module characteristics such as the frequency the second wireless communication module 140B is configured to operate, transmission power configured for at ideal operating range of the second wireless communication module 140B, the physical layer (PHY) configuration of the second wireless communication module 140B, gain of the signal transmission from the second wireless communication module 140B, and examples of the like. The first maximum range 110A may be different to the second maximum range 110B based on wireless communication module characteristics configured. Illustratively, reference to the term maximum range regarding first maximum range 110A and second maximum range 110B does not necessarily represent an absolute distance in which no data packets may be successfully transmitted and received. Rather, the first maximum range 110A and second maximum range 110B may encompass distances (which may be dynamic) in which threshold levels of quality of transmissions are not achieved consistently.

The mobile electronic device 120 is operable to establish separate communication channels with the recipient device(s) 130 via the first wireless communication module 140A and second wireless communication module 140B. By way of example, the first wireless communication module 140A and the second wireless communication module 140B are configured to implement a Bluetooth wireless communication protocol and can also be generally referred to as first Bluetooth wireless communication component (or module) and second Bluetooth wireless communication component (or module). The first wireless communication module 140A and second wireless communication module 140B may be Bluetooth modules where the first wireless communication module 140A and second wireless communication module 140B operate on configurable channels. In some examples, the first wireless communication module 140A may be configured to operate on the same frequency channel as the second wireless communication module 140B, with a difference in range capabilities based on the first wireless communication module 140A and second wireless communication module 140B configuration. In other examples, the first wireless communication module 140A may be configured to operate on a separate frequency channel than the second wireless communication module 140B (e.g., the first wireless communication module 140A operating on a 5 GHz frequency, and the second wireless communication module 140B operating on a 2.4 GHz frequency) with the second wireless communication module 140B configured to operate with a wider range of coverage.

System 100A illustrates an example of the first maximum range 110A and second maximum range 110B wherein the first wireless communication module 140A and second wireless communication module 140B may transmits data packets in real time, individually from each other or simultaneously. Responsive to a connection request, the mobile electronic device 120 may select the first wireless communication module 140A to establish a connection with a recipient device(s) 130 and designate the first coverage as a primary channel or in an active state. The electronic device may retrieve a designated hardware identifier (e.g., media access control (MAC) address, etc.) and establish a second connection with the recipient device(s) 130 via the second wireless communication module 140B as a standby transmission.

At some point, a distance between the mobile electronic device 120 or the recipient device(s) 130 may exceed the first maximum range 110A with respect to the first wireless communication module 140A. In such scenarios, data transmitted from the mobile electronic device 120 includes packet losses as a function, at least in part, on the distance exceeding the first maximum range 110A. The recipient device(s) 130 includes a configurable threshold of transmission metric information, such as a rate of packet loss. If the transmission metric information, such as rate of the packet loss or other metrics (e.g., SNR, BER, PER, etc.), are greater than the threshold amount, the recipient device(s) 130 to inform the mobile electronic device 120 as part of a header information defined in the wireless transmission protocol. The packet losses introduced enables the electronic device to begin transmitting data packets as a second designated transmission via the second wireless communication module 140B, in parallel with the first wireless communication module 140A.

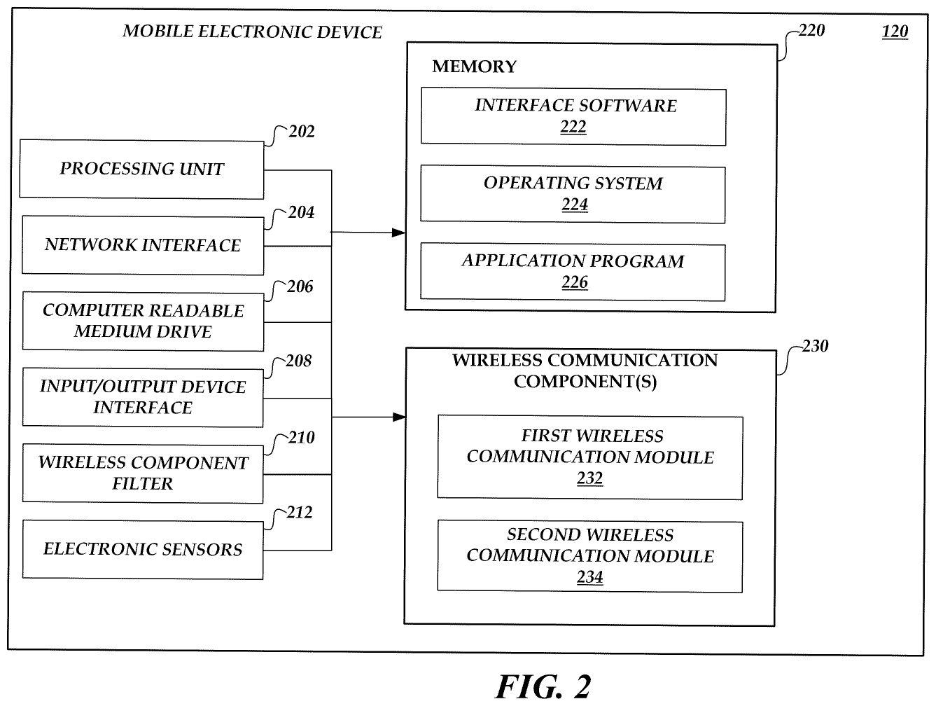

The mobile electronic device 120A may further configure, via the wireless component filter (described in FIG. 2 below), the transmission of the data packets via the first wireless communication module 140A and second wireless communication module 140B, wherein the first wireless communication module 140A and second wireless communication module 140B may transmit duplicate packets in a configurable sequential order. The sequential order may be configured as an alternating sequential order from the first wireless communication module 140A and second wireless communication module 140B. The description related to the sequential order of the data transmission are illustrative of the data transmission configuration implemented by the mobile electronic device 120 and not limited to such description.

The recipient device(s) 130 receives the transmission of the data packets from the first wireless communication module 140A and second wireless communication module 140B and performs a packet reassembly of the transmitted data packets to reduce the packet loss rate and enhance latency and throughput of the data transmission. Furthermore, the mobile electronic device 120 may transmit the data packets via the first wireless communication module 140A and second wireless communication module 140B in a configurable sequence. For example, the mobile electronic device 120 may utilize controllers, such as an interleaver, to organize the packet sequence reducing burst error.

FIG. 1B is a system diagram of an example embodiment of system 100B for implementing a dual Bluetooth transceiver communication system in accordance with various aspects of the present application. As previously described in FIG. 1A, the system 100B can include an mobile electronic device 120 that is includes a first wireless communication module 140A and a second wireless communication module 140B that enable wireless communication (e.g., file transfer, data streaming) with a recipient device(s) 130. Furthermore, system 100B represents a local area that includes congestion device(s) 150 that may transmit signals in similar (or substantially similar) frequency channels (e.g., 2.4 GHZ, 5 GHZ, 6 GHZ, etc.). Illustratively, as described above, a first wireless communication module 140A may be configured, at least in part, transmit signals in overlapping frequency range. Alternatively, the second wireless communication module 140B may be configured, at least in part, to transmit signals in overlapping frequency range. In such scenarios, transmission from either the first wireless communication module 140A and a second wireless communication module 140B may be subject to interference or competitive transmissions from the congestion device(s) 150, which can be generally referred to as frequency congestion.

The congestion device(s) 150 may be an example of a plurality of congestion device(s) 150 that may be occupying a local area wherein the mobile electronic device 120 and recipient device(s) 130 are operating. The congestion device(s) 150 may be occupying the frequency channel via Bluetooth communication protocol, Wi-Fi communication protocol, or any other wireless communication protocols of the like. Congestion device(s) 150 may introduce an increase in latency for the data transmission between the mobile electronic device 120 and the recipient device(s) 130.

Responsive to a connection request, the mobile electronic device 120 may select the first wireless communication module to establish a connection with a recipient device(s) 130 and designate the first coverage as a primary channel or in an active state. Once a connection is established, mobile electronic device 120 requests the first wireless communication module 140A to perform a first adaptive frequency hopping (AFH) scan with respect to a first frequency channel the first wireless communication module 140A is configured to operate on. Furthermore, mobile electronic device 120 requests the second wireless communication module 140B to perform a second AFH scan with respect to the second frequency channel the second wireless communication module 140B is configured to operate on. The first wireless communication module 140A and second wireless communication module 140B communicate the first AFH results and second AFH results to an application program controller on the mobile electronic device 120. The application program controller processes the first AFH results and second AFH results and determines if the first AFH results and second first AFH results are below a congestion threshold.

If the first AFH results is below the congestion threshold, the electronic device may retrieve a designated hardware identifier and establish a second connection with the recipient device(s) 130 via the second wireless communication module 140B as a standby transmission and configure the first wireless communication module 140A to transmit data packets to the recipient device(s) 130 via the first frequency channel.

If the first AFH results is greater than congestion threshold, the electronic device may retrieve a designated hardware identifier and establish a second connection with the recipient device(s) 130 via the second wireless communication module 140B and transmit data packets to the recipient device(s) 130 via the second frequency channel. The electronic device may configure the first wireless communication module 140A as a standby transmission.

Mobile electronic device 120 may begin transmitting data packets to the recipient device(s) 130 via the first wireless communication module 140A and request addition electronic sensor(s) 160A and 160B to monitor the location of the recipient device(s) 130. Mobile electronic device 120 may monitor the location of the recipient device(s) 130 via electronic sensor(s) 160A and 160B (e.g., Wi-Fi module, etc.) to identify Wi-Fi roaming, motion information, of the recipient device(s) 130 moving in the local area. When movement of the recipient device(s) 130 is determined the application program controller 226 of FIG. 2, may request a first wireless communication module 140A and a second wireless communication module 140B to perform a first AFH scan and second AFH scan with respect to the operating frequency channel of the modules.

The program application will determine if the connection with the first wireless communication module 140A and second wireless communication module 140B is greater than or less than congestion threshold. Based on the first AFH result and second AFH result, the program application may maintain current connection and transmission of data packets with the first wireless communication module 140A.

Furthermore, based on the first AFH result and second AFH result, the program application may configure the first wireless communication module 140A as a standby transmission and configure the second wireless communication module 140B to transmit data packets to the recipient device(s) 130 based on a determination that a signal quality (e.g., signal to noise ratio (SNR), packet error rate (PER), etc.) of the second frequency channel is greater than the first frequency channel.

FIG. 2 depicts a block diagram of an example architecture of the mobile electronic device 120 utilized for dual Bluetooth transceiver communication of FIG. 1A and FIG. 1B. The general architecture of mobile electronic device 120 is depicted in FIG. 2 includes an arrangement of hardware and software components that may be used to implement aspects of the mobile electronic device 120 of FIGS. 1A and 1B. As illustrated the mobile electronic device 120 includes a processing unit 202, a network interface 204, computer readable medium drive 206, input/output device interface 208, wireless component filter 210, electronic sensors 212, memory 220, and wireless communication component(s) 230. The processing unit may receive instructions to establish communication with the recipient device(s) 130 of FIGS. 1A and 1B via a first wireless communication module 232 and/or a second wireless communication module 234.

The input/output device interface 208, may include interfacing hardware for further connection with the mobile electronic device 120. Memory 220 includes interface software 222, an operating system 224, and an application program controller 226 wherein the application program controller may operate in the back end without terminating application process (e.g., daemon program, etc.).

Network interface 204 can provide connectivity of the mobile electronic device 120 to a network not illustrated in FIGS. 1A and 1B. The processing unit 202 can receive information and instructions from a user via the input/output device interface 208. The processing unit 202 can also communicate to and from memory 220 and the wireless communication component(s) 230 where the wireless communication component(s) 230 is comprised of a first wireless communication module 232 and a second wireless communication module 234 that may establish a connection with the recipient device(s) 130.

The first wireless communication module 232 and the second wireless communication module 234 may be configured to implement a Bluetooth wireless communication protocol and can also be generally referred to as first Bluetooth wireless communication component (or module) and second Bluetooth wireless communication component (or module). The first wireless communication module 232 and second wireless communication module 234 may be Bluetooth modules where the first wireless communication module 232 and second wireless communication module 234 operate on configurable channels.

In some examples, the first wireless communication module 232 may be configured to operate on the same frequency channel as the second wireless communication module 234, with a difference in range capabilities based on the first wireless communication module 232 and second wireless communication module 234 configuration. In other examples, the first wireless communication module 232 may be configured to operate on a separate frequency channel than the second wireless communication module 234 (e.g., the first wireless communication module 232 operating on a 5 GHz frequency, and the second wireless communication module 234 operating on a 2.4 GHz frequency) with the second wireless communication module 234 configured to operate with a wider range of coverage.

The range of coverage may be configured based on factors such as the frequency of first wireless communication module 232 and second wireless communication module 234 configured to operate on, transmission power configured for at ideal operating range of the first wireless communication module 232 and second wireless communication module 234, the physical layer (PHY) configuration of the first wireless communication module 232 and second wireless communication module 234, gain of the signal transmission from the first wireless communication module 232 and second wireless communication module 234, and examples of the like.

Memory 220 can correspond to a non-transitory computer-readable medium that includes computer program instructions that the processing unit 202 executes in order to implement one or more examples of the mobile electronic device 120. Memory 220 generally includes RAM, ROM, or other persistent or non-transitory memory. Memory 220 can store an operating system 224 that provides computer program instructions for use by the processing unit 202. Memory 220 can further include computer program instructions and other information for implementing aspects of the mobile electronic device 120. For example, memory 220 includes Interface software 222 for communicating with the reservation server recipient device(s) 130.

The memory 220 can further include an application program controller 226 for managing communication connection between the mobile electronic device 120 and the recipient device(s) 130 via the first wireless communication module 232 and the second wireless communication module 234 based on the examples as described with respect to FIG. 1B. The application program controller 226 may determine to perform a first AFH scan and a second AFH scan via the first wireless communication module 232 and second wireless communication module 234 bases on a connection established with a first wireless communication module 232. Further, the application program controller 226 may request for the first wireless communication module 232 or second wireless communication module 234 as standby transmission based on the AFH results and further request the electronic sensor(s) 160A and 160B of FIG. 1B to monitor the location of the recipient device(s) 130. The electronic sensor(s) 160A and 160B will communicate information regarding the recipient device(s) 130 location to the application program controller 226 wherein the application program controller 226 may further request another first AFH scan and second AFH scan. The application program controller 226 may request a signal quality check of the connection between the mobile electronic device 120 and recipient device(s) 130 and further determine to change transmission packets via the first wireless communication module 232 to the second wireless communication module 234.

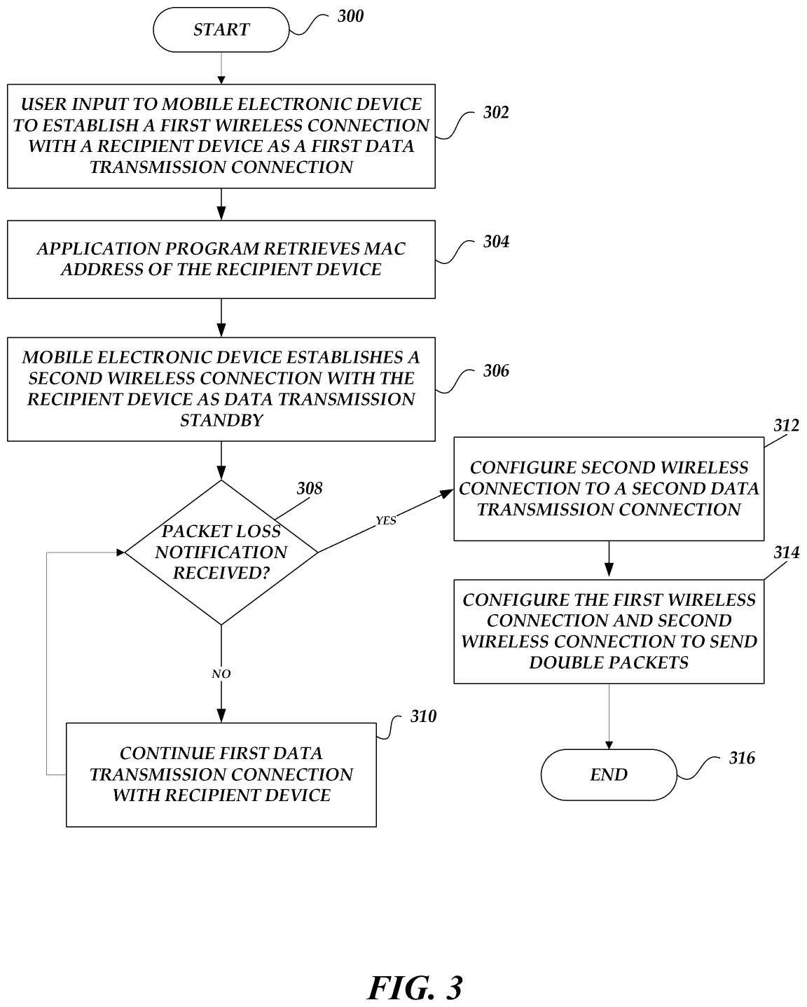

With reference now to FIGS. 3, 4 and 5, illustrative routines will be described in which an mobile electronic device 120 can establish two communication channels with a recipient device(s) 130 and configure transmission of data packets. Illustratively the transmission of data packets are illustratively described regarding Bluetooth transmission protocols. Additionally, the two communication channels are established by utilization of the first wireless communication module 140A and a second wireless communication module 140B in a manner that the two communication modules are independently operable and configurable as described in FIGS. 3, 4 and 5.

FIG. 3 is a flow diagram of a routine implemented by the mobile electronic device 120 of FIGS. 1A and 1B establishing and configuring connection with a recipient device(s) 130 of FIGS. 1A and 1B. Illustratively, the routine illustrated in FIG. 3 may be implemented in scenarios in which real-time or substantial real-time communications between the mobile electronic device 120 and the recipient device(s) 130 are required or preferred. At block 302, responsive to a connection request, the mobile electronic device 120 establishes a first wireless connection with a recipient device(s) 130 as a first data transmission connection. The first data transmission connection is established via a first wireless communication module 140A of FIGS. 1A and 1B. At block 304, the application program controller retrieves the MAC address of the recipient device(s) 130 and requests for the electronic device to establish a second connection with the recipient device(s) 130.

At block 306, the electronic device establishes a second connection with the recipient device(s) 130 via a second wireless communication module. The application program controller configures the first wireless communication module 140A as a data transmission active or primary communication module or that the first wireless communication module 140A is in an active state. Illustratively, the first wireless communication module 140A and the second wireless communication module 140B may be configured to operate on the same frequency (e.g., 2.4 GHz, 5 GHZ, 6 GHZ, etc.) with differing range widths based on configurable module characteristics. The application program controller configures the second wireless communication module 140B as a data transmission standby communication module or that the second wireless communication module 140B is in a standby state. Mobile electronic device 120 is configured to transmit data packets to the recipient device(s) 130 via the first wireless communication module.

The recipient device(s) 130 may transmit information to the mobile electronic device 120 including transmission metric information indicative of packet loss according to transmission utilizing the first connection as a response to the recipient device(s) 130 moving to the edge of the first maximum range 110A of FIGS. 1A and 1B. At decision block 308, the mobile electronic device 120 may determine if a transmission metric information with sufficient amount of packet loss has occurred, was received by the recipient device(s) 130. At block 310, if transmission metric information without sufficient amount of packet loss has occurred, was received, the mobile electronic device 120 continues the current packet transmission via the first wireless communication module to the recipient device(s) 130.

In another embodiment, at block 308, if a transmission metric information with sufficient amount of packet loss has occurred was received, the application program controller will configure the second wireless communication module to a second data transmission connection as represented at block 312. At block 314, the application program controller may configure the packet transmission via the first wireless communication module and second wireless communication module to send double packet. Furthermore, the application program controller may configure the first wireless communication module and second wireless communication module to transmit data packets in a configurable sequence. The first wireless communication module and second wireless communication module are configured to work in parallel to reduce latency and packet losses. By way of illustration, the transmission of double packets data transmissions may be beneficial for real-time communication examples.

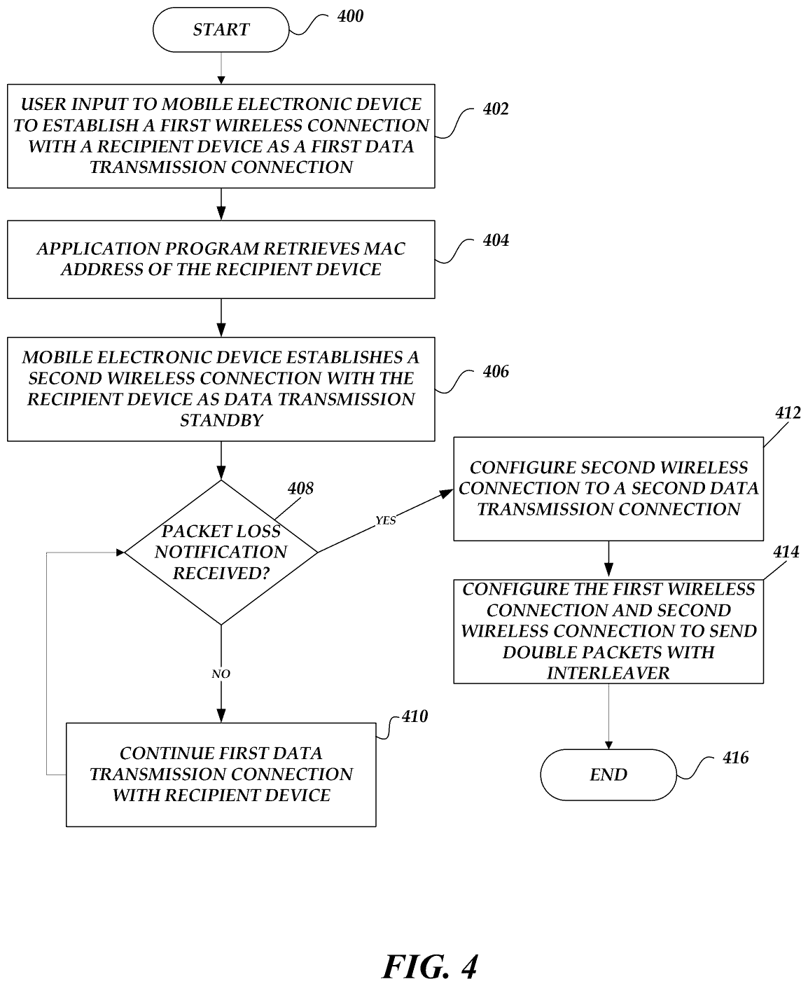

FIG. 4 is a flow diagram of a routine implemented by the mobile electronic device 120 of FIGS. 1A and 1B establishing and configuring connection with a recipient device(s) 130 of FIGS. 1A and 1B. Illustratively, the routine illustrated in FIG. 4 may be implemented in scenarios in which real-time or substantial non-real-time communications between the mobile electronic device 120 and the recipient device(s) 130 are required or preferred. At block 402, responsive to a connection, the mobile electronic device 120 establishes a first wireless connection with a recipient device(s) 130 as a first data transmission connection. The first data transmission connection is established via a first wireless communication module 140A of FIGS. 1A and 1B. At block 404, the application program controller retrieves the MAC address of the recipient device(s) 130 and requests for the electronic device to establish a second connection with the recipient device(s) 130. At block 406, the electronic device establishes a second connection with the recipient device(s) 130 via a second wireless communication module. The application program controller configures the first wireless communication module 140A as a data transmission active or primary communication module or that the first wireless communication module 140A is in an active state. Illustratively, the first wireless communication module 140A and the second wireless communication module 140B may be configured to operate on the same frequency (e.g., 2.4 GHz, 5 GHZ, 6 GHZ, etc.) with differing range widths based on configurable module characteristics. The application program controller configures the second wireless communication module 140B as a data transmission standby communication module or that the second wireless communication module 140B is in a standby state. Mobile electronic device 120 is configured to transmit data packets to the recipient device(s) 130 via the first wireless communication module.

The recipient device(s) 130 may transmit information to the mobile electronic device 120 including transmission metric information indicative of packet loss according to transmission utilizing the first connection as a response to the recipient device(s) 130 moving to the edge of the first maximum range 110A of FIGS. 1A and 1B. At decision block 408, the mobile electronic device 120 may determine if a transmission metric information with sufficient amount of packet loss has occurred was received by the recipient device(s) 130. At block 410, if transmission metric information without sufficient amount of packet loss has occurred was received, the mobile electronic device 120 continues the current packet transmission via the first wireless communication module to the recipient device(s) 130.

In another embodiment, at block 408, if a transmission metric information with sufficient amount of packet loss has occurred was received, the application program controller will configure the second wireless communication module to a second data transmission connection as represented at block 412. At block 414, the application program controller may configure the packet transmission via the first wireless communication module and second wireless communication module to send double packet with an interleaver. Furthermore, the application program controller may configure the first wireless communication module and second wireless communication module to transmit data packets in a configurable sequence. The first wireless communication module and second wireless communication module are configured to work in parallel to reduce latency and packet losses. By way of illustration, the transmission of interleaved data transmissions may be beneficial for non-real-time communication examples.

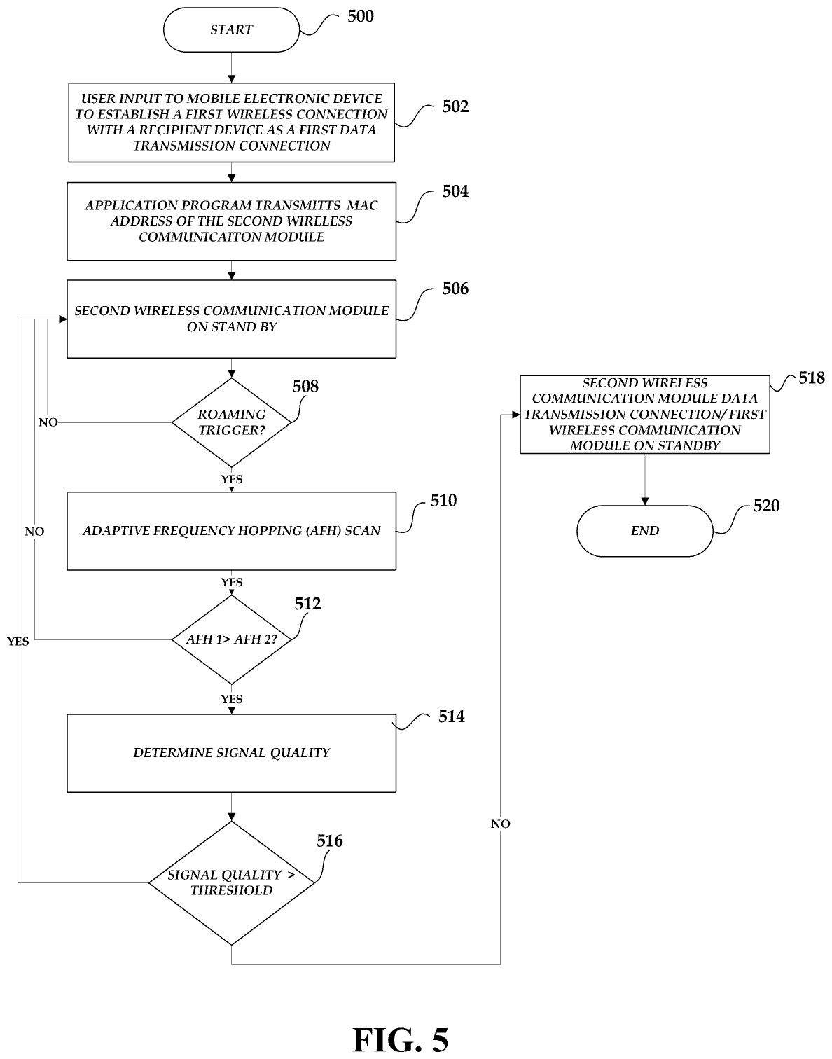

FIG. 5 is a flow diagram of a routine implemented by the mobile electronic device 120 of FIGS. 1A and 1B establishing and configuring a connection with a recipient device(s) 130 of FIGS. 1A and 1B with congestion device(s) 150 occupying a frequency channel in the local area. At block 502 responsive to a connection request to the mobile electronic device 120 to establish a first wireless connection with a recipient device(s) 130 as a first data transmission connection. Responsive to the connection request, establish a connection with the recipient device(s) 130 in an attempt to transfer data in real time (e.g., audio transmission, etc.). Furthermore, responsive to the connection request, establish a connection with the recipient device(s) 130 in an attempt to transfer a file to the recipient device(s) 130 using the first wireless communication module 140A of FIGS. 1A and 1B. Once the first wireless communication module 140A has established a connection with the recipient device(s) 130 the application program controller will request, from the first wireless communication module 140A and a second wireless communication module 140B of FIGS. 1A and 1B, adaptive frequency hopping scan of the respective connections.

The first wireless communication module and second wireless communication module may communicate the results of the AFH scan to the application program controller, wherein the application program controller determines the wireless communication module with the least amount of congesting device occupying the respective frequency channel. The Application program controller may determine to connect to a first wireless communication module 140A based on the determination that the respective frequency channel the first wireless communication module 140A is operating on has the least number of occupants, the application program controller configures the first wireless communication module 140A as a data transmission active or primary communication module or that the first wireless communication module 140A is in an active state. Illustratively, the first wireless communication module 140A and the second wireless communication module 140B may be configured to operate on the same different frequency (e.g., 2.4 GHZ, 5 GHZ, 6 GHz, etc.) with differing range widths based on configurable module characteristics.

At block 504, the application program controller transmits a media access control (MAC) address of the second wireless communication module 140B via the first wireless communication module 140A to establish a connection with the recipient device(s) 130 via a second wireless communication module 140B. Furthermore, the application program controller may retrieve the MAC address of the recipient device(s) 130 via the first wireless communication module 140A and communicate the MAC address to the second wireless communication module 140B to establish a second connection with the recipient device(s) 130. At block 506, the application program controller configures the second wireless communication module 140B as a transmission standby communication module or that the second wireless communication module 140B is in a standby state.

At decision block 508, the application program controller request addition electronic sensor(s) 160A and 160B of FIG. 1B to monitor the recipient device(s) 130 and determine if the recipient device(s) 130 is traveling to the edge of first maximum range 110A of FIGS. 1A and 1B. In an embodiment where the recipient device(s) 130 is not roaming the first wireless communication module 140A continues to transmit data packets to the recipient device(s) 130 in an active state and the second wireless communication module 140B is configured as a standby state.

In another embodiment, at decision block 508, the addition electronic sensor(s) 160A and 160B may determine that the recipient device(s) 130 is roaming while communicating with the first wireless communication module 140A, the addition electronic sensor(s) 160A and 160B inform the application program controller. The application program controller may request another AFH scan to evaluate channel congestion of the frequency channel the first wireless communication module 140A and second wireless communication module 140B are configured to operate on.

At block 510, the application program controller request the first wireless communication module 140A and second wireless communication module 140B to perform a AFH scan to determine if the first connection has a congestion level is greater than a second congestion level wherein the first congestion level is a representation of the congestion of the first frequency channel with respect to the first wireless communication module 140A and the second congestion level is a representation of the of the congestion of the second frequency channel with respect to the second wireless communication module 140B.

At decision block 512, the application program controller processes and determines the results of the AFH scan, wherein if the first congestion level is less than the second congestion level the applicant program maintains the first wireless communication module 140A as transmitting data packets, an active state, and the second wireless communication module 140B as standby state.

In another embodiment, at block 512, the application program controller processes and determines the results of the AFH scan, wherein if the first congestion level is greater than the second congestion level the applicant program submits a request for the first wireless communication module 140A to conduct a signal quality analysis and communicate the information to the application program controller. At block 514, the first wireless communication module 140A conducts the signal quality analysis (e.g., SNR, PER, BER, etc.) and may determine information related to the signal quality of the first wireless communication module 140A.

At decision block 516, the application program controller processes the signal quality analysis and determines if the signal quality is greater than a predefined threshold wherein based on the determination, the application program controller continues to transmit data packets to the recipient device(s) 130 via the first wireless communication module 140A in an active state and maintains the second wireless communication module 140B as standby state.

In another embodiment, at decision block 516, the application program controller processes the signal quality analysis and determines if the signal quality is less than a predefined threshold wherein based on the determination, the application program controller reconfigures the communication with between the mobile electronic device 120 and the recipient device(s) 130.

At block 518, the application program controller submits a request to the second wireless communication module 140B to establish a packet transmission connection between the mobile electronic device 120 as an active state and the recipient device(s) 130 via a second frequency channel and configures the first wireless communication module 140A to a standby state.

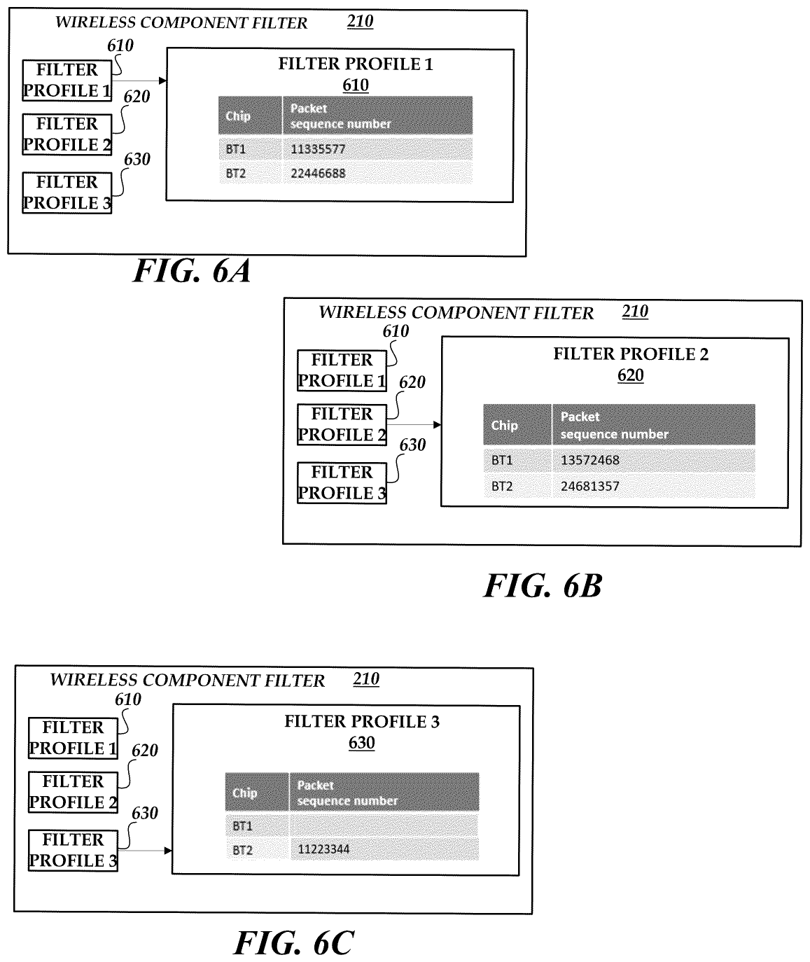

FIG. 6A-6C are illustrative examples of a wireless component filter 210 with filter profile 1 610, filter profile 2 620, filter profile 3 630, wherein each filter profile may be configured to filter data transmission via a first wireless communication module and/or a second wireless communication module based on a configured packet sequence. The wireless component filter 210 may be utilized for implementing the packet sequence in the illustrative routines with regards to the FIGS. 3-5. The application program controller may request based on a determination that a recipient device(s) 130 of FIGS. 1A and 1B is moving to the edge of the first maximum range 110A of FIGS. 1A and 1B of the first wireless communication module. The application program controller may determine to configure the second wireless communication module to transmit data packets to the recipient device(s) 130 in parallel with the first wireless communication module utilizing a filter profile 1 610. The filter profile 1 610 may configure the first and second wireless communication module to transmit data packets in an odd number or even number sequence wherein the first wireless communication module transmits an odd number sequence of the assigned data packets, and the second wireless communication module transmits an even number sequence of the assigned data packets. Furthermore, the first wireless communication module and second wireless communication module may transmit duplicate packets of the assigned data packets in the odd number sequential order or even number sequential order.

In another embodiment, the application program controller may request, based on a determination that a recipient device(s) 130 is moving to the edge of the first maximum range 110A of FIGS. 1A and 1B of the first wireless communication module. The application program controller may determine to configure the second wireless communication module to transmit data packets interleaved, to the recipient device(s) 130 in parallel with the first wireless communication module utilizing a filter profile 2 620. The filter profile 2 620 may configure the first wireless communication module and second wireless communication module to send in parallel, assigned data packets arranged to include the full transmission, from the first wireless communication module and second wireless communication module.

In another embodiment, the application program controller may request, based on a determination that a recipient device(s) 130 and mobile electronic device 120 are operating via a first frequency channel by way of the first wireless communication module with a congested frequency channel. Further determining, that a second frequency channel is advantageously configured to communicate with the recipient device(s) 130 via a second frequency channel by way of the second wireless communication module. The application program controller further configuring the second wireless communication module to transmit data packets, utilizing a filter profile 3 630 via a second frequency channel, and configuring the first wireless communication module as standby transmission. The filter profile 3 630 may configure the second wireless communication module may include the full transmission of the data packets. The filter profile 3 630 may further configure the second wireless communication module to transmit the full transmission of the data packets with duplicate packets. The filter profiles with respect to filter profile 1 610, filter profile 2 620, and filter profile 3 630 are non-limiting examples of the types of filter profile that the first wireless communication module and second wireless communication module may be configured to operate as.

Conditional language such as, among others, “can,” “could,” “might,” or “may,” unless specifically stated otherwise, are otherwise understood within the context as used in general to convey that certain examples include, while other examples do not include, certain features, elements, and/or blocks. Thus, such conditional language is not generally intended to imply that features, elements, and/or blocks are in any way required for any examples or that any example necessarily includes logic for deciding, with or without user input or prompting, whether these features, elements, and/or blocks are included or are to be performed in any particular example.

Disjunctive languages such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Any process descriptions, elements or blocks in the flow diagrams described herein and/or depicted in the attached figures should be understood as potentially representing modules, segments, or portions of code which include computer-executable instructions for implementing specific logical functions or elements in the process. Alternate implementations are included within the scope of the examples described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

What is claimed is:

1. A non-transitory computer readable medium comprising computer executable instructions that, when executed by a processor of an mobile electronic device, cause the mobile electronic device to:
connect with a recipient device over a first connection via a first Bluetooth transceiver of the mobile electronic device and a second connection via a second Bluetooth transceiver of the mobile electronic device;
transmit data packets to the recipient device over the first connection, wherein the second connection corresponds to a standby communications state; and
in response to a determination that a signal quality of the first connection is below a threshold, transmit data packets to the recipient device via a combination of the first connection and second connection.

2. The non-transitory computer readable medium of claim 1, wherein the computer executable instructions when executed, further causes the mobile electronic device to establish the second connection via a second Bluetooth transceiver by transmitting identification information of the second Bluetooth transceiver via the first connection.

3. The non-transitory computer readable medium of claim 1, wherein the computer executable instructions when executed, further causes the processor to transmit data packets to the recipient device via a combination of the first connection and second connection utilizing a wireless transmission filter.

4. The non-transitory computer readable medium of claim 1, wherein the computer executable instructions when executed, further causes the processor to determine that a signal quality of the first connection based on packet losses of data transmission.

5. The non-transitory computer readable medium of claim 1, wherein the computer executable instructions when executed, further causes the processor to transmit data packets to the recipient device via a combination of the first connection and second connection wherein the first connection is configured to transmit a first sequence of data to the recipient device and the second connection is configured to transmit a second sequence of data to the recipient device.

6. The non-transitory computer readable medium of claim 1, wherein the computer executable instructions when executed, further causes the processor to transmit data packets to the recipient device via a combination of the first connection and second connection on a same frequency.

7. The non-transitory computer readable medium of claim 1, wherein the computer executable instructions when executed, further causes the processor to receive from the recipient device, signal quality information corresponding to the first connection.

8. The non-transitory computer readable medium of claim 1, wherein the second Bluetooth transceiver has wider coverage area than the first Bluetooth transceiver.

9. A mobile electronic device comprising:
a first wireless communication module and second wireless communication module, wherein the first wireless communication module transmits data packets according to a frequency channel configuration and wherein the second wireless communication module transmits data packets according to the frequency channel configuration,
a controller for managing data packet transmissions from the first wireless communication module and second wireless communication module to recipient devices based on transmission configuration; and
a processor to:
connect with a recipient device over a first connection via the first wireless communication module and a second connection via second wireless communication module;
transmit data packets to the recipient device over the first connection, wherein the second connection is in a standby communications state; and
in response to a determination that a signal quality of the first connection is below a threshold, transmit data packets in sequential order to the recipient device via a combination of the first connection and second connection.

10. The mobile electronic device of claim 9, wherein the processor transmits double data packets via the first connection and second connection.

11. The mobile electronic device of claim 9, wherein the processor is further to establish the second connection based on receiving identification information of the second wireless communication module via the first connection.

12. The mobile electronic device of claim 9, wherein the first wireless communication module is configured on a same frequency channel as the second wireless communication module.

13. The mobile electronic device of claim 9, wherein the second wireless communication module has a further range of coverage than the first wireless communication module with respect to a location of the mobile electronic device.

14. The mobile electronic device of claim 13, wherein in response to the determination that the signal quality of the first connection is below the threshold, the processor is further to transmit data packets interleaved to the recipient device via the combination of the first connection and second connection.

15. An mobile electronic device comprising:
an electronic component;
a first Bluetooth transceiver;
a second Bluetooth transceiver; and
a processor to:
connect with a recipient device over a first connection via the first Bluetooth transceiver and a second connection via the second Bluetooth transceiver, wherein the first connection is configured with a first frequency channel corresponding to a first transmission frequency and the second connection is configured with a second frequency channel corresponding to a second transmission frequency;
transmit data packets to the recipient device over the first connection, wherein the second connection is set to a standby communication state; and
in response to evaluation of a channel congestion and signal quality information associated with the first connection, transmit data packets to the recipient device using the second connection, wherein the first connection is set to a standby communication state.

16. The mobile electronic device of claim 15, wherein the first Bluetooth transceiver and second Bluetooth transceiver utilize adaptive frequency hopping to identify a first frequency channel and second frequency channel congestion.

17. The mobile electronic device of claim 15, wherein the electronic component transmits identification information of the second Bluetooth transceiver to the recipient device via the first connection establishing the second connection with the recipient device.

18. The mobile electronic device of claim 15, wherein the processor requests the electronic component to monitor a location of the recipient device.

19. The mobile electronic device of claim 18, wherein the electronic component is a wireless communication module.

20. The mobile electronic device of claim 15, wherein the processor evaluates the channel congestion and signal quality information associated with the first connection based on a response to receiving motion information detected by the electronic component.
